(19) United States
(12) Patent Application Publication
(10) Pub. No.: US 2026/0040098 A1
(43) Pub. Date: Feb. 5, 2026

(54) LBT FAILURE IN SIDELINK UNLICENSED

(71) Applicant: Apple Inc., Cupertino, CA (US)

(72) Inventors: Peng Cheng, Beijing (CN); Alexander Sirotkin, Hod Hasharon (IL); Chunxuan Ye, San Diego, CA (US); Fangli Xu, Beijing (CN); Haijing Hu, Los Gatos, CA (US); Huaning Niu, San Jose, CA (US); Ping-Heng Kuo, London (GB); Ralf Rossbach, Munich (DE); Yuqin Chen, Beijing (CN); Zhibin Wu, Los Altos, CA (US)

(21) Appl. No.: 19/099,910

(22) PCT Filed: Jul. 26, 2023
(86) PCT No.: PCT/US2023/028704

§ 371 Date: Jan. 30, 2025

Related U.S. Application Data
(60) Provisional application No. 63/395,373, filed on Aug. 5, 2022.

(51) Int. Cl. H04W 24/04; H04W 74/0808; H04W 92/18

(52) U.S. Cl. CPC H04W 24/04; H04W 74/0808; H04W 92/18

(57) ABSTRACT

Disclosed are methods, systems, and computer-readable media to perform operations including: detecting a listen-be-fore-talk (LBT) failure on a channel of a sidelink interface used to communicate with a second UE, where the first UE and the second UE are served by a base station; and responsive to detecting the LBT failure on the channel, performing a recovery procedure including reporting LBT failure information to at least one of the base station or the second UE.

### CROSS-REFERENCE TO RELATED APPLICATIONS

The present application claims priority to U.S. Prov. App. No. 63/395,373, filed on Aug. 5, 2022, entitled “LBT FAILURE IN SIDELINK UNLICENSED,” which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

In some wireless communications networks, a user equipment (UE) may communicate with another UE without having the communication routed through a network node, using what is referred to as sidelink communication. A transmitting UE that wants to initiate sidelink communication may determine the available resources (e.g., sidelink resources) and may select a subset of these resources to communicate with a receiving UE based on a resource allocation scheme. Existing protocols support sidelink communication using Mode 1 and Mode 2 resource allocation schemes. In Mode 1 resource allocation scheme (also referred to as “Mode 1”), the resources are allocated by a network node for in-coverage UEs. In Mode 2 resource allocation scheme (also referred to as “Mode 2”), the transmitting UE selects the sidelink resources (e.g., sidelink transmission resources).

### SUMMARY

This disclosure describes methods and systems for handling listen-before-talk (LBT) failure in unlicensed sidelink. The disclosed methods and systems are designed to account for features of sidelink, and therefore, are different than existing LBT failure handling mechanisms (e.g., for interfaces other than sidelink). The disclosed methods and systems support handling LBT failure in all Radio Resource Control (RRC) states, including an idle state, an inactive state, and an out of coverage (OOC) state. Further, the disclosed methods and systems support handling LBT failure in both Mode 1 and Mode 2 resource allocation schemes. Yet further, the disclosed methods and systems support handling LBT failure per destination (e.g., per destination UE).

In accordance with one aspect of the present disclosure, a method to be performed by a user equipment (UE) is disclosed. The method involves: detecting a listen-before-talk (LBT) failure on a channel of a sidelink interface used to communicate with a second UE, where the first UE and the second UE are served by a base station; and responsive to detecting the LBT failure on the channel, performing a recovery procedure including reporting LBT failure information to at least one of the base station or the second UE.

The previously-described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other implementations may each optionally include one or more of the following features.

In some implementations, detecting the LBT failure on the channel includes: detecting a threshold number of LBT failure instances on the channel before an LBT failure detection timer expires, where the LBT failure detection timer is restarted upon detecting an LBT failure instance.

In some implementations, performing the recovery procedure includes: declaring radio link failure of the channel; triggering an upper layer of the first UE to run a keep-alive check; and in response to determining that the first UE is in a connected state, reporting the LBT failure information to the base station.

In some implementations, performing the recovery procedure includes: selecting, from a plurality of component carriers used for carrier aggregation, at least one new component carrier different from an initial component carrier on which the LBT failure is detected; and reporting the LBT failure information to the second UE via the at least one new component carrier.

In some implementations, performing the recovery procedure includes: in response to determining that the UE is not in a connected state, entering the connected state for failure information reporting; and reporting the LBT failure information to the base station via a Uu interface.

In some implementations, the channel is a first channel, and performing the recovery procedure includes: starting a timer for reporting the failure information via an exceptional resource pool of the sidelink interface; attempting to perform LBT on a second channel using the exceptional resource pool; if the LBT is successful prior to the timer expiring, stopping the timer; and if the LBT is not successful prior to the timer expiring, declaring radio link failure of the first channel.

In some implementations, the method further includes: generating a message that includes the LBT failure information, the message further including at least one of: (i) carrier information, (ii) a type of transmission, (iii) measurements for the sidelink interface, (iv) measurements for a Uu interface, or (iv) a cast type.

In some implementations, the type of transmission includes SL-SSB, PSFCH, PSCCH, SL DRB, SL-SRB0, SL-SRB1, SL-SRB2, SL-SRB 3, or SL-SRB4.

In some implementations, the cast type includes broadcast, groupcast or unicast.

In some implementations, the message is one of a PC5 RRC message, a sidelink MAC-CE, a Uu MAC-CE, or a cause value field in a Uu RRC message.

In some implementations, the sidelink MAC-CE is assigned a highest priority CAPC.

In some implementations, the sidelink MAC-CE has a priority between data of an SCCH and a CSI reporting MAC-CE during a sidelink LCP procedure.

In some implementations, the Uu MAC-CE has a priority between an LBT failure MAC-CE and a MAC-CE for prioritized SL-BSR during a Uu LCP procedure.

In some implementations, reporting LBT failure information to at least one of the base station or the second UE includes reporting the LBT failure information to both the base station and the second UE.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example communication system that includes sidelink communications, according to some implementations.

FIG. 2 illustrates a flowchart for handling LBT failure in sidelink unlicensed, according to some implementations.

FIG. 3A and FIG. 3B illustrate example scenarios of an RX UE determining whether LBT failure has occurred, according to some implementations.

FIG. 4 illustrates a flowchart of an example method, according to some implementations.

FIG. 5 illustrates a user equipment (UE), according to some implementations.

FIG. 6 illustrates an access node, according to some implementations.

Like reference numbers and designations in the various drawings indicate like elements.

### DETAILED DESCRIPTION

One of the areas for study and development in Release 18 of the Third Generation Partnership Project (3GPP) technical standards is a sidelink interface operating in an unlicensed spectrum (also referred to as “sidelink unlicensed”). In particular, the study and development include channel access mechanisms, sidelink resource reservation procedures, physical channel design frameworks, and sidelink physical channel structures and procedures for sidelink unlicensed. The advantage of sidelink unlicensed is the ability to accommodate the continually increasing demand for wireless data traffic. Additionally, sidelink unlicensed can achieve better latency (e.g., quality of service [QoS]) from the perspective of a user equipment (UE) compared to the achievable latency through a Uu interference. Further, some use cases and device types may especially benefit from sidelink unlicensed. Example use cases include home networks, personal networks, industrial networks, etc., and example device types include internet-of-things (IoT) devices, wearable devices, relay devices, etc.

Like other communication in the unlicensed spectrum, sidelink unlicensed uses the listen-before-talk (LBT) mechanism to access a channel. In Mode 1 resource allocation scheme, a transmitting UE (TX UE) receives downlink control information (DCI, e.g., format 3-0) on a licensed downlink (DL) carrier. The DCI schedules a sidelink transmission on an unlicensed carrier. After receiving the DCI, the TX UE performs LBT in order to transmit information to a receiving UE (RX UE) via the unlicensed carrier. In Mode 2 RA, the TX UE performs specified sensing and a reserved based mechanism with LBT before transmitting information to the RX UE. However, for various reasons, LBT in either mode may fail.

This disclosure describes methods and systems for handling LBT failure in unlicensed sidelink. The disclosed methods and systems are designed to account for features of sidelink, and therefore, are different than existing LBT failure handling mechanisms (e.g., for interfaces other than sidelink). The disclosed methods and systems support handling LBT failure in all Radio Resource Control (RRC) states, including an idle state, an inactive state, and an out of coverage (OOC) state. Further, the disclosed methods and systems support handling LBT failure in both Mode 1 and Mode 2 resource allocation schemes. Yet further, the disclosed methods and systems support handling LBT failure per destination (e.g., per destination UE).

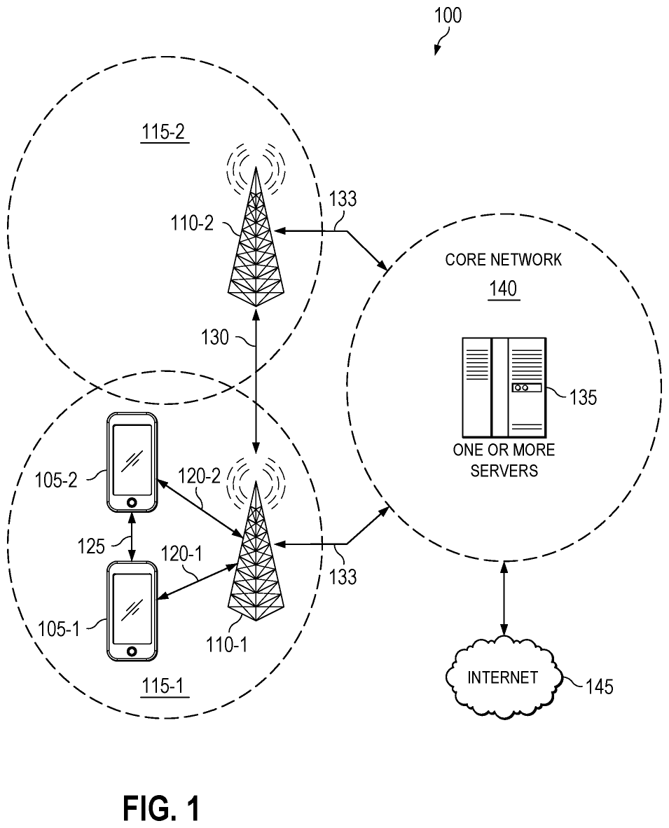

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard, and the described examples may apply to other networks that may benefit from the principles described herein, such as 3GPP Long Term Evolution (LTE) networks, Wi-Fi, and the like. Furthermore, other types of communication standards are possible, including future 3GPP systems (e.g., Sixth Generation (6G)) or the like. While aspects may be described herein using terminology commonly associated with 5G NR, aspects of the present disclosure can be applied to other systems, such as 4G and/or systems subsequent to 5G (e.g., 6G).

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communications protocols, such as a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB). The signaling radio bearers may have different types including SL-SRB0, SL-SRB1, SL-SRB2, SL-SRB3, and SL-SRB4.

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short-to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may generally refer to devices that are associated with mobile actors or traffic participants in the V2X system, e.g., mobile (able-to-move) communication devices such as vehicles, pedestrian user equipment (PUE) devices, and roadside units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the UEs 105 are configured to implement an LBT failure recovery procedure for sidelink. For the purposes of this disclosure, a UE that is initiating a communication with another UE is referred to as a TX UE, and the UE receiving the communication is referred to as an RX UE. For example, UE 105-1 may be a TX UE, and UE 105-2 may be an RX UE. Further, although FIG. 1 illustrates a single TX UE communicating with a single RX UE, a TX UE may communicate with more than one RX UE via sidelink.

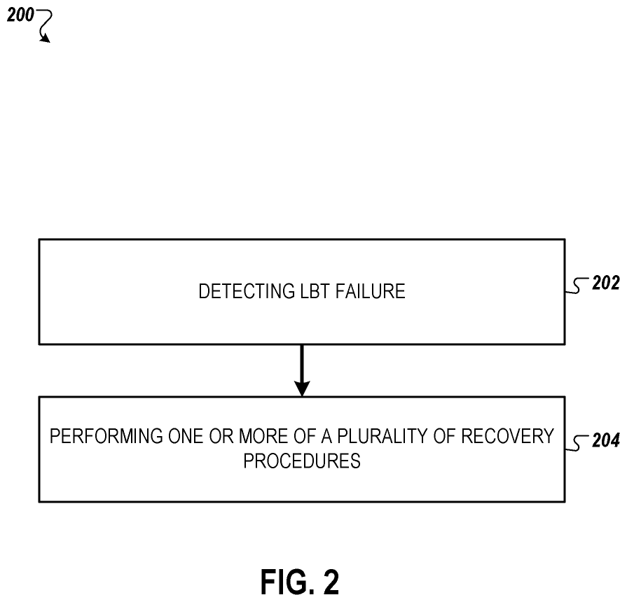

FIG. 2 illustrates a workflow 200 for LBT failure recovery, according to some implementations. The workflow 200 can be implemented by a TX UE that is transmitting (or scheduled to transmit) a sidelink communication to an RX UE. The RX UE and the TX UE are served by a common base station (e.g., base station 110). The workflow 200 can be implemented by a TX UE operating in any RRC state, including idle, inactive, connected, or OOC. Furthermore, the workflow 200 can be implemented by a TX UE that is using Mode 1 resource allocation scheme or Mode 2 resource allocation scheme.

The workflow 200 starts at step 202. At step 202, the TX UE detects LBT failure. In one example, the TX UE determines that LBT failure occurs after detecting a threshold number of LBT failure instances, perhaps within a threshold amount of time. The threshold number of failure instances and/or the threshold amount of time may be received from a serving base station, perhaps in a sidelink-specific LBT configuration. The sidelink-specific LBT configuration may include a counter (e.g., LBT_COUNTER) and/or a timer per destination (e.g., LBT_TIMER) for LBT failure detection purposes. In one example, detecting sidelink LBT failure is performed by a medium access control (MAC) layer of the TX UE.

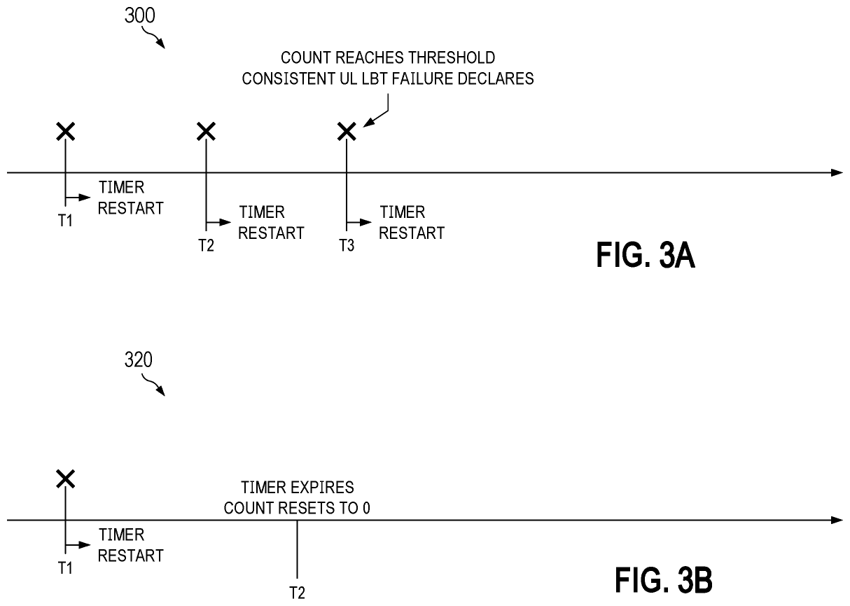

FIG. 3A and FIG. 3B illustrate example scenarios of a TX UE determining whether a LBT failure has occurred, according to some implementations. The TX UE starts an LBT failure detection timer when the TX UE begins to monitor for LBT failure. In scenario 300 of FIG. 3A, the TX UE at time T1 detects a first instance of LBT failure. In response to detecting the failure instance, the TX UE resets the LBT failure detection timer and increases the value of the LBT failure counter by 1. Then, at time T2, the TX UE detects a second instance of LBT failure. Here, like at T1, the TX UE resets an LBT failure detection timer and increases the value of the LBT failure counter by 1. At time T3, the TX UE detects a third instance of LBT failure. Here, like at T1 and T2, the TX UE resets an LBT failure detection timer and increases the value of the LBT failure counter by 1. However, in this example, the counter has now exceeded a predetermined threshold. In response to determining that the counter has exceeded the predetermined threshold, the TX UE determines that LBT failure has occurred.

In scenario 320 of FIG. 3B, the TX UE at time T1 detects a first instance of LBT failure. In response to detecting the instance, the TX UE resets the LBT failure detection timer and increases the value of the LBT failure counter by 1. However, in this scenario, the TX UE does not detect another LBT failure instance until the timer expires. Accordingly, the TX UE determines that an LBT failure has not occurred and resets the value of the LBT failure counter to zero.

Returning to FIG. 2, in response to detecting that LBT failure has occurred, the TX UE performs one or more of a plurality of recovery procedures, as shown by step 204. A recovery procedure involves sending the RX UE and/or the serving base station LBT failure information. The LBT failure information enables reestablishment of a sidelink channel on which the TX UE can transmit data to the RX UE. The LBT failure information and the signaling that carries the failure information are described in more detail below.

In a first recovery procedure, “recovery procedure 1,” the TX UE declares sidelink radio link failure (RLF). In this procedure, the TX UE declares RLF on sidelink in response to detecting LBT failure on a sidelink channel. The TX UE then triggers an upper layer to run a keep-alive check, which is a mechanism running in a PC5 signaling protocol stack called PC5-S. The keep-alive check checks whether the link between the two UEs is still viable. Under this mechanism, the TX UE will periodically send PC5-S signaling to check whether the RX UE can respond, so that TX UE can determine whether the RX UE is operating (alive). Then, the TX UE reports the failure information to the serving base station if the TX UE is an RRC connected state. If the TX UE is not in an RRC connected state, then the TX UE first transitions to the RRC connected state in order to report the failure information. As described in more detail below, the failure information can be sent in a Uu RRC message or in a MAC-CE. In one example, the failure information can be reported in a cause of failure message created for sidelink LBT failure. The TX UE can apply the first recovery procedure in Mode 1 or Mode 2 resource allocation schemes, and in all RRC states.

In a second recovery procedure, “recovery procedure 2,” the TX UE reports the failure information to the RX UE. The TX UE can apply the second recovery procedure in scenarios where PC5 carrier aggregation (CA) is configured. In this procedure, in response to detecting the LBT failure, the TX UE reports the failure information to the RX UE via a PC5 carrier different from the PC5 carrier on which the LBT failure was detected. Upon reception of the failure information, the RX UE may negotiate with the TX UE on PC5 RRC reconfiguration. The reconfiguration includes reconfiguration of the TX resource pool, RX resource pool, transmit power, among other parameters. The TX UE can apply this procedure in Mode 1 or Mode 2 resource allocation schemes, and in all RRC states.

In a third recovery procedure, “recovery procedure 3,” the TX UE reports the failure information to the serving base station. Unlike in recovery procedure 1, the TX UE in this procedure does not declare sidelink RLF in response to detecting sidelink LBT failure. Rather, the TX UE reports the failure information to the serving base station without declaring sidelink RLF. If the TX UE is not in an RRC connected state, then the TX UE can request to enter the RRC connected state for failure information reporting. The TX UE can apply this recovery procedure in Mode 1 or Mode 2 resource allocation schemes. However, the TX UE does not apply this recovery procedure if the TX UE is OOC.

In a fourth recovery procedure, “recovery procedure 4,” the TX UE uses an exceptional resource pool for reporting failure information. The exceptional resource pool can be time division multiplexed with the normal resource pool. In this procedure, the TX UE starts a timer for recovery via the exceptional resource pool. The TX UE then performs LBT to send failure information to the RX UE via the exceptional resource pool. If the LBT is successful, the TX UE stops the timer. Then, the RX UE may negotiate with the TX UE PC5 RRC reconfiguration upon receipt of the failure information. The TX UE can apply this procedure in Mode 1 or Mode 2 resource allocation schemes, and in all RRC states. Conversely, if the timer expires prior to the LBT being successful on the exceptional resource pool, then the TX UE performs the first recovery procedure.

In some implementations, the serving base station may configure the TX UE to perform a combination of recovery procedure 2, recovery procedure 3, and recovery procedure 4. For example, the base station can configure the TX UE to report failure information to both the RX UE and the base station (e.g., using recovery procedures 2 and 3). The serving base station may configure the TX UE with the procedure(s) to perform via pre-configuration, configuration in a system information block (SIB), or Uu configuration.

In some implementations, the signaling of failure information to the RX UE (e.g., in recovery procedures 2, 4) can be sent in a PC5 RRC message or in a sidelink MAC-CE. The sidelink MAC-CE can have a fixed Logical Channel ID (LCID). In some examples, the signaling can include at least one of: (i) carrier information, (ii) a type of transmission (sidelink Synchronization Signal Block (SL-SSB), PSFCH, PSCCH, SL-DRB, SL-SRB0/1/2/3/4), or (iii) a cast type (e.g., broadcast, groupcast, unicast) of the sidelink channel on which LBT failure was detected. Additionally and/or alternatively, the signaling can include available PC5 measurements and/or Uu measurements.

In some implementations, during a Logical Channel Prioritization (LCP) procedure, the priority of the MAC-CE is between data of a sidelink control channel (SCCH) and a Channel State Information (CSI) reporting MAC-CE. For example, the priority during the LCP procedure is: SCCH>LBT failure MAC-CE>CSI reporting MAC-CE>data from sidelink traffic logical channel (STCH). In some implementations, the LBT failure MAC-CE is assigned a highest priority Channel Access Priority Class (CAPC), where CAPC is used to determine a priority of a communication for accessing the unlicensed channel.

In some implementations, the signaling of failure information to the base station (e.g., in recovery procedures 1, 3) can be sent in a Uu RRC message or in a MAC-CE that has a fixed LCID. In an example, the failure information can be sent in a new cause value (e.g., LBT failure) in a Uu RRC message SidelinkUEInformationNR. The MAC-CE can include at least one of: (i) carrier information, (ii) a type of transmission (e.g., SL-SSB, PSFCH, PSCCH, SL-DRB, SL-SRB0/1/2/3/4), or (iii) cast type (e.g., broadcast, groupcast, unicast). During a Uu LCP procedure, the priority of the sidelink LBT failure MAC-CE is between an LBT failure MAC-CE and a MAC-CE for prioritized SL-Buffer Status Reporting (BSR). In an example, the Uu LCP procedure described in 3GPP TS 38.321 V16.5.0 can be modified such that the priority (from high to low) is as follows:
C-RNTI MAC-CE or data from UL-CCCH;
Configured Grant Confirmation MAC-CE or MAC-CEs for beam failure report (BFR) or Multiple Entry Configured Grant Confirmation MAC-CE;
Sidelink Configured Grant Confirmation MAC-CE;
LBT failure MAC-CE;
Sidelink LBT failure MAC-CE;
MAC-CE for SL-BSR prioritized according to clause 5.22.1.6;
MAC-CE for BSR, with exception of BSR included for padding;
Single Entry power headroom report (PHR) MAC-CE or Multiple Entry PHR MAC-CE;
MAC-CE for the number of Desired Guard Symbols;
MAC-CE for Pre-emptive BSR;
MAC-CE for SL-BSR, with exception of SL-BSR prioritized according to clause 5.22.1.6 and SL-BSR included for padding;
data from any Logical Channel, except data from uplink-common control channel (UL-CCCH);
MAC-CE for Recommended bit rate query;
MAC-CE for BSR included for padding;
MAC-CE for SL-BSR included for padding.

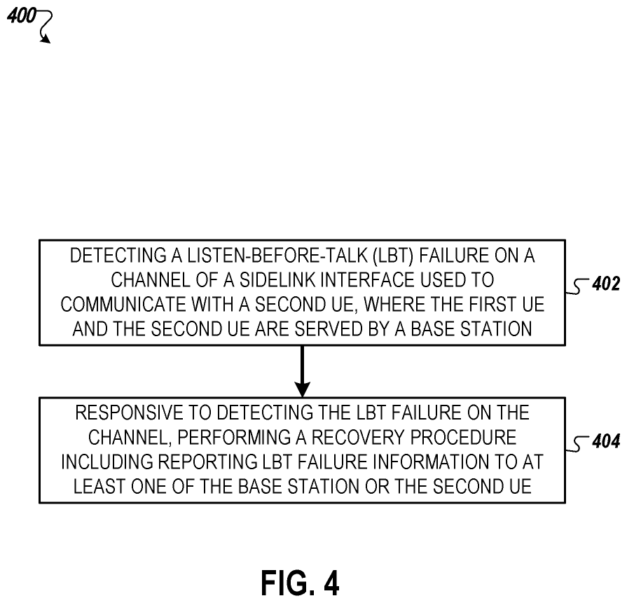

FIG. 4 illustrates a flowchart of an example method 400, according to some implementations. For clarity of presentation, the description that follows generally describes method 400 in the context of the other figures in this description. For example, method 400 can be performed by UEs 105 of FIG. 1. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order. In some implementations, method 400 is performed by a first UE.

At step 402, method 400 involves detecting a listen-before-talk (LBT) failure on a channel of a sidelink interface used to communicate with a second UE, where the first UE and the second UE are served by a base station.

At step 404, method 400 involves responsive to detecting the LBT failure on the channel, performing a recovery procedure including reporting LBT failure information to at least one of the base station or the second UE.

In some implementations, detecting the LBT failure on the channel includes: detecting a threshold number of LBT failure instances on the channel before an LBT failure detection timer expires, where the LBT failure detection timer is restarted upon detecting an LBT failure instance.

In some implementations, performing the recovery procedure includes: declaring radio link failure of the channel; triggering an upper layer of the first UE to run a keep-alive check; and in response to determining that the first UE is in a connected state, reporting the LBT failure information to the base station.

In some implementations, performing the recovery procedure includes: selecting, from a plurality of component carriers used for carrier aggregation, at least one new component carrier different from an initial component carrier on which the LBT failure is detected; and reporting the LBT failure information to the second UE via the at least one new component carrier.

In some implementations, performing the recovery procedure includes: in response to determining that the UE is not in a connected state, entering the connected state for failure information reporting; and reporting the LBT failure information to the base station via a Uu interface.

In some implementations, the channel is a first channel, and performing the recovery procedure includes: starting a timer for reporting the failure information via an exceptional resource pool of the sidelink interface; attempting to perform LBT on a second channel using the exceptional resource pool; if the LBT is successful prior to the timer expiring, stopping the timer; and if the LBT is not successful prior to the timer expiring, declaring radio link failure of the first channel.

In some implementations, the method further includes: generating a message that includes the LBT failure information, the message further including at least one of: (i) carrier information, (ii) a type of transmission, (iii) measurements for the sidelink interface, (iv) measurements for a Uu interface, or (iv) a cast type.

In some implementations, the type of transmission includes SL-SSB, PSFCH, PSCCH, SL-DRB, SL-SRB0, SL-SRB1, SL-SRB2, SL-SRB 3, or SL-SRB4.

In some implementations, the cast type includes broadcast, groupcast, or unicast.

In some implementations, the message is one of a PC5 RRC message, a sidelink MAC-CE, a Uu MAC-CE, or a cause value field in a Uu RRC message.

In some implementations, the sidelink MAC-CE is assigned a highest priority CAPC.

In some implementations, the sidelink MAC-CE has a priority between data of an SCCH and a CSI reporting MAC-CE during a sidelink LCP procedure.

In some implementations, the Uu MAC-CE has a priority between an LBT failure MAC-CE and a MAC-CE for prioritized SL-BSR during a Uu LCP procedure.

In some implementations, reporting LBT failure information to at least one of the base station or the second UE includes reporting the LBT failure information to both the base station and the second UE.

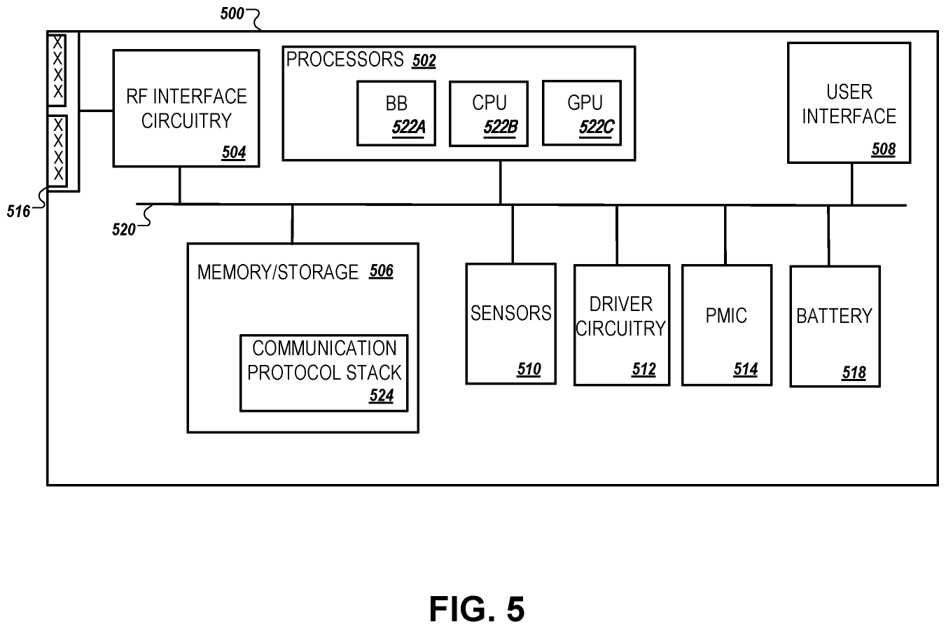

FIG. 5 illustrates a UE 500, according to some implementations. The UE 500 may be similar to and substantially interchangeable with UE 105 of FIG. 1.

The UE 500 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smartwatch), relaxed-IoT devices.

The UE 500 may include processors 502, RF interface circuitry 504, memory/storage 506, user interface 508, sensors 510, driver circuitry 512, power management integrated circuit (PMIC) 514, one or more antennas 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and different arrangements of the components shown may occur in other implementations.

The components of the UE 500 may be coupled with various other components over one or more interconnects 520, which may represent any type of interface, input/output, bus (local, system, or expansion), transmission line, trace, optical connection, etc. that allows various circuit components (on common or different chips or chipsets) to interact with one another.

The processors 502 may include processor circuitry such as, for example, baseband processor circuitry (BB) 522A, central processor unit circuitry (CPU) 522B, and graphics processor unit circuitry (GPU) 522C. The processors 502 may include any type of circuitry, or processor circuitry that executes or otherwise operates computer-executable instructions, such as program code, software modules, or functional processes from memory/storage 506 to cause the UE 500 to perform operations as described herein.

In some implementations, the processors 502 are configured to perform operations that cause the UE to detect a listen-before-talk (LBT) failure on a channel of a sidelink interface used to communicate with a second UE, where the first UE and the second UE are served by a base station. Further, the processors 502 are configured to perform operations that cause the UE to responsive to detecting the LBT failure on the channel, performing a recovery procedure including reporting LBT failure information to at least one of the base station or the second UE.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based on cyclic prefix orthogonal frequency division multiplexing (OFDM) “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by one or more of the processors 502 to cause the UE 500 to perform various operations described herein. The memory/storage 506 includes any type of volatile or non-volatile memory that may be distributed throughout the UE 500. In some implementations, some of the memory/storage 506 may be located on the processors 502 themselves (for example, L1 and L2 cache), while other memory/storage 506 is external to the processors 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via one or more antennas 516 and proceed to filter and amplify (with a low-noise amplifier) the signal. The signal may be provided to a receiver of the transceiver that downconverts the RF signal into a baseband signal that is provided to the baseband processor of the processors 502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 516. In various implementations, the RF interface circuitry 504 may be configured to transmit/receive signals in a manner compatible with NR access technologies.

The antenna 516 may include antenna elements to convert electrical signals into radio waves to travel through the air and convert received radio waves into electrical signals. The antenna elements may be arranged into one or more antenna panels. The antenna 516 may have antenna panels that are omnidirectional, directional, or a combination thereof to enable beamforming and multiple input, multiple output communications. The antenna 516 may include microstrip antennas, printed antennas fabricated on the surface of one or more printed circuit boards, patch antennas, phased array antennas, etc. The antenna 516 may have one or more panels designed for specific frequency bands including bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in their environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensors 510 and control and allow access to sensors 510, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processors 502, the PMIC 514 may control power-source selection, voltage scaling, battery charging, or DC-to-DC conversion.

In some implementations, the PMIC 514 may control, or otherwise be part of, various power saving mechanisms of the UE 500. A battery 518 may power the UE 500, although in some examples the UE 500 may be mounted deployed in a fixed location, and may have a power supply coupled to an electrical grid. The battery 518 may be a lithium-ion battery, a metal-air battery, such as a zinc-air battery, an aluminum-air battery, a lithium-air battery, and the like. In some implementations, such as in vehicle-based applications, the battery 518 may be a typical lead-acid automotive battery.

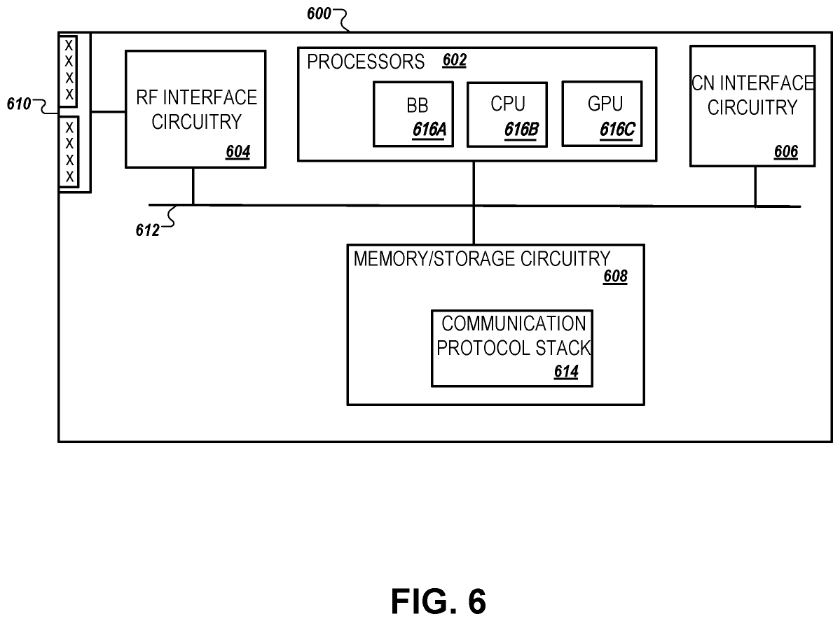

FIG. 6 illustrates an access node 600 (e.g., a base station or gNB), according to some implementations. The access node 600 may be similar to and substantially interchangeable with base station 110 of FIG. 1. The access node 600 may include processors 602, RF interface circuitry 604, core network (CN) interface circuitry 606, memory/storage circuitry 608, and one or more antennas 610.

The components of the access node 600 may be coupled with various other components over one or more interconnects 612. The processors 602, RF interface circuitry 604, memory/storage circuitry 608 (including communication protocol stack 614), one or more antennas 610, and interconnects 612 may be similar to like-named elements shown and described with respect to FIG. 5. For example, the processors 602 may include processor circuitry such as, for example, baseband processor circuitry (BB) 616A, central processor unit circuitry (CPU) 616B, and graphics processor unit circuitry (GPU) 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells, or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In V2X scenarios, the access node 600 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 USC § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

### EXAMPLES

In the following section, further exemplary embodiments are provided.

Example 1 includes one or more processors of a first user equipment (UE), the one or more processors configured to perform operations including: detecting a listen-before-talk (LBT) failure on a channel of a sidelink interface used to communicate with a second UE, wherein the first UE and the second UE are served by a base station; and responsive to detecting the LBT failure on the channel, performing a recovery procedure comprising reporting LBT failure information to at least one of the base station or the second UE.

Example 2 is the one or more processors of Example 1, wherein detecting the LBT failure on the channel includes: detecting a threshold number of LBT failure instances on the channel before an LBT failure detection timer expires, wherein the LBT failure detection timer is restarted upon detecting an LBT failure instance.

Example 3 is the one or more processors of any of Examples 1-2, wherein performing the recovery procedure includes: declaring radio link failure of the channel; triggering an upper layer of the first UE to run a keep-alive check; and in response to determining that the first UE is in a connected state, reporting the LBT failure information to the base station.

Example 4 is the one or more processors of any of Examples 1-2, wherein performing the recovery procedure includes: selecting, from a plurality of component carriers used for carrier aggregation, at least one new component carrier different from an initial component carrier on which the LBT failure is detected; and reporting the LBT failure information to the second UE via the at least one new component carrier.

Example 5 is the one or more processors of any of Examples 1-2, wherein performing the recovery procedure includes: in response to determining that the UE is not in a connected state, entering the connected state for failure information reporting; and reporting the LBT failure information to the base station via a Uu interface.

Example 6 is the one or more processors of any of Examples 1-2, wherein the channel is a first channel, and wherein performing the recovery procedure includes: starting a timer for reporting the failure information via an exceptional resource pool of the sidelink interface; attempting to perform LBT on a second channel using the exceptional resource pool; if the LBT is successful prior to the timer expiring, stopping the timer; and if the LBT is not successful prior to the timer expiring, declaring radio link failure of the first channel.

Example 7 is the one or more processors of any of Examples 1-6, the operations further including: generating a message that includes the LBT failure information and at least one of: (i) carrier information, (ii) a type of transmission, (iii) measurements for the sidelink interface, (iv) measurements for a Uu interface, or (iv) a cast type.

Example 8 is the one or more processors of Example 7, wherein the type of transmission includes sidelink Synchronization Signal Block (SL-SSB), Physical Sidelink Feedback Channel (PSFCH), Physical Sidelink Control Channel (PSCCH), sidelink Data Radio Bearer (SL-DRB), sidelink Signaling Radio Bearer 0 (SL-SRB0), SL-SRB1, SL-SRB2, SL-SRB 3, or SL-SRB4.

Example 9 is the one or more processors of Example 7, wherein the cast type includes broadcast, groupcast or unicast.

Example 10 is the one or more processors of Example 7, wherein the message is one of a PC5 Radio Resource Control (RRC) message, a sidelink medium access control (MAC) control element (CE), a Uu MAC-CE, or a cause value field in a Uu RRC message.

Example 11 is the one or more processors of Example 10, wherein the sidelink MAC-CE is assigned a highest priority Channel Access Priority Class (CAPC).

Example 12 is the one or more processors of Example 10, wherein the sidelink MAC-CE has a priority between data of a sidelink control channel (SCCH) and a Channel State Information (CSI) reporting MAC-CE during a sidelink Logical Channel Prioritization (LCP) procedure.

Example 13 is the one or more processors of Example 10, wherein the Uu MAC-CE has a priority between an LBT failure MAC-CE and a MAC-CE for prioritized SL-Buffer Status Reporting (SL-BSR) during a Uu Logical Channel Prioritization (LCP) procedure.

Example 14 is the one or more processors of any of Examples 1-13, wherein reporting LBT failure information to at least one of the base station or the second UE comprises reporting the LBT failure information to both the base station and the second UE.

Example 15 may include a non-transitory computer storage medium encoded with instructions that, when executed by one or more computers, cause the one or more computers to perform the operations of any of Examples 1 to 14.

Example 16 may include a system including one or more computers and one or more storage devices on which are stored instructions that are operable, when executed by the one or more computers, to cause the one or more computers to perform the operations of any of Examples 1 to 14.

Example 17 may include a method for performing the operations of any of Examples 1 to 14.

Example 18 may include an apparatus including logic, modules, or circuitry to perform one or more elements of the operations described in or related to any of Examples 1-14, or any other operations or process described herein.

Example 19 may include a method, technique, or process as described in or related to the operations of any of Examples 1-14, or portions or parts thereof.

Example 20 may include an apparatus including: one or more processors and one or more computer-readable media including instructions that, when executed by the one or more processors, cause the one or more processors to perform the method, techniques, or process as described in or related to the operations of any of Examples 1-14, or portions thereof.

Example 21 may include a signal as described in or related to any of Examples 1-14, or portions or parts thereof.

Example 22 may include a datagram, information element (IE), packet, frame, segment, PDU, or message as described in or related to any of Examples 1-14, or portions or parts thereof, or otherwise described in the present disclosure.

Example 23 may include a signal encoded with data as described in or related to any of Examples 1-14, or portions or parts thereof, or otherwise described in the present disclosure.

Example 24 may include a signal encoded with a datagram, IE, packet, frame, segment, PDU, or message as described in or related to any of Examples 1-14, or portions or parts thereof, or otherwise described in the present disclosure.

Example 25 may include an electromagnetic signal carrying computer-readable instructions, wherein execution of the computer-readable instructions by one or more processors is to cause the one or more processors to perform the method, techniques, or process as described in or related to the operations of any of Examples 1-14, or portions thereof.

Example 26 may include a computer program including instructions, wherein execution of the program by a processing element is to cause the processing element to carry out the method, techniques, or process as described in or related to the operations of any of examples 1-14, or portions thereof. The operations or actions performed by the instructions executed by the processing element can include the operations of any one of Examples 1-14.

Example 27 may include a signal in a wireless network as shown and described herein.

Example 28 may include a method of communicating in a wireless network as shown and described herein.

Example 29 may include a system for providing wireless communication as shown and described herein. The operations or actions performed by the system can include the operations of any one of Examples 1-14.

Example 30 may include a device for providing wireless communication as shown and described herein. The operations or actions performed by the device can include the operations of any one of Examples 1-14.

The previously-described operations of Examples 1-14 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors of a first user equipment (UE), the one or more processors configured to perform operations comprising:
detecting a listen-before-talk (LBT) failure for a sidelink transmission associated with a channel of a sidelink interface used to communicate with a second UE, wherein the first UE and the second UE are served by a base station; and
responsive to detecting the LBT failure on the channel, performing a recovery procedure comprising reporting LBT failure information to at least one of the base station or the second UE.

2. The one or more processors of claim 1, wherein detecting the LBT failure on the channel comprises:
detecting a threshold number of LBT failure instances associated with the channel before an LBT failure detection timer expires, wherein the LBT failure detection timer is restarted upon detecting an LBT failure instance.

3. The one or more processors of claim 1, wherein performing the recovery procedure comprises:
declaring radio link failure of the channel;
triggering an upper layer of the first UE to run a keep-alive check; and
in response to determining that the first UE is in a connected state, reporting the LBT failure information to the base station.

4. The one or more processors of claim 1, wherein performing the recovery procedure comprises:
selecting, from a plurality of component carriers used for carrier aggregation, at least one new component carrier different from an initial component carrier on which the LBT failure is detected; and
reporting the LBT failure information to the second UE via the at least one new component carrier.

5. The one or more processors of claim 1, wherein performing the recovery procedure comprises:
in response to determining that the UE is not in a connected state, entering the connected state for failure information reporting; and
reporting the LBT failure information to the base station via a Uu interface.

6. The one or more processors of claim 1, wherein the channel is a first channel, and wherein performing the recovery procedure comprises:
starting a timer for reporting the LBT failure information via an exceptional resource pool of the sidelink interface;
attempting to perform LBT on a second channel using the exceptional resource pool;
if the LBT is successful prior to the timer expiring, stopping the timer; and
if the LBT is not successful prior to the timer expiring, declaring radio link failure of the first channel

7. The one or more processors of claim 1, the operations further comprising:
generating a message that includes the LBT failure information and at least one of: (i) carrier information, (ii) a type of transmission, (iii) measurements for the sidelink interface, (iv) measurements for a Uu interface, or (iv) a cast type.

8. The one or more processors of claim 7, wherein the type of transmission comprises sidelink Synchronization Signal Block (SL-SSB), Physical Sidelink Feedback Channel (PSFCH), Physical Sidelink Control Channel (PSCCH), sidelink Data Radio Bearer (SL-DRB), sidelink Signaling Radio Bearer 0 (SL-SRB0), SL-SRB1, SL-SRB2, SL-SRB 3, or SL-SRB4.

9. The one or more processors of claim 7, wherein the cast type comprises broadcast, groupcast, or unicast.

10. The one or more processors of claim 7, wherein the message is one of a PC5 Radio Resource Control (RRC) message, a sidelink medium access control (MAC) control element (CE), a Uu MAC-CE, or a cause value field in a Uu RRC message.

11. The one or more processors of claim 10, wherein the sidelink MAC-CE is assigned a highest priority Channel Access Priority Class (CAPC).

12. The one or more processors of claim 10, wherein the sidelink MAC-CE has a priority between data of a sidelink control channel (SCCH) and a Channel State Information (CSI) reporting MAC-CE during a sidelink Logical Channel Prioritization (LCP) procedure.

13. The one or more processors of claim 10, wherein the Uu MAC-CE has a priority between an LBT failure MAC-CE and a MAC-CE for prioritized SL-Buffer Status Reporting (SL-BSR) during a Uu Logical Channel Prioritization (LCP) procedure.

14. The one or more processors of claim 1, wherein reporting the LBT failure information to at least one of the base station or the second UE comprises reporting the LBT failure information to both the base station and the second UE.

15. A non-transitory computer storage medium encoded with instructions that, when executed by one or more computers, cause the one or more computers to perform the operations of claim 1.

16. A system comprising one or more computers and one or more storage devices on which are stored instructions that are operable, when executed by the one or more computers, to cause the one or more computers to perform operations comprising:
detecting, by a first user equipment (UE), a listen-before-talk (LBT) failure for a sidelink transmission associated with a channel of a sidelink interface used to communicate with a second UE, wherein the first UE and the second UE are served by a base station; and
responsive to detecting the LBT failure on the channel, performing, by the first UE, a recovery procedure comprising reporting LBT failure information to at least one of the base station or the second UE.

17. A method for performing operations comprising:
detecting, by a first user equipment (UE), a listen-before-talk (LBT) failure for a sidelink transmission associated with a channel of a sidelink interface used to communicate with a second UE, wherein the first UE and the second UE are served by a base station; and
responsive to detecting the LBT failure on the channel, performing, by the first UE, a recovery procedure comprising reporting LBT failure information to at least one of the base station or the second UE.

18. The method of claim 17, wherein detecting the LBT failure on the channel comprises:
detecting a threshold number of LBT failure instances associated with the channel before an LBT failure detection timer expires, wherein the LBT failure detection timer is restarted upon detecting an LBT failure instance.

19. The method of claim 17, wherein performing the recovery procedure comprises:
declaring radio link failure of the channel;
triggering an upper layer of the first UE to run a keep-alive check; and
in response to determining that the first UE is in a connected state, reporting the LBT failure information to the base station.

20. The method of claim 17, wherein performing the recovery procedure comprises:
selecting, from a plurality of component carriers used for carrier aggregation, at least one new component carrier different from an initial component carrier on which the LBT failure is detected; and
reporting the LBT failure information to the second UE via the at least one new component carrier.
